(19) United States
(12) Patent Application Publication
(10) Pub. No.: US 2026/0268467 A1
(43) Pub. Date: Sep. 10, 2026

(54) ELECTRONIC DEVICE AND METHOD OF MONITORING CRACK IN STRUCTURE

(71) Applicant: Electronics and Telecommunications Research Institute, Daejeon (KR)

(72) Inventors: Sang Yun LEE, Daejeon (KR); Dongjun SHIN, Daejeon (KR)

(21) Appl. No.: 19/349,851

(22) Filed: Oct. 3, 2025

(30) Foreign Application Priority Data
Mar. 10, 2025 (KR) 10-2025-0030504

(51) Int. Cl. G06T 7/00; G06T 7/246; G06V 10/25; G06V 20/52

(52) U.S. Cl. CPC G06T 7/0002; G06T 7/251; G06T 2207/20081; G06T 2207/20212; G06T 2207/30184; G06V 10/25; G06V 20/52

(57) ABSTRACT

An electronic device and a method of monitoring a crack in a structure are provided. The method includes obtaining a panoramic image comprising the structure, setting a plurality of points of interest (POIs) within the panoramic image, by analyzing cracks within the plurality of POIs, generating a bounding box corresponding to each of areas in which the cracks have occurred, and monitoring the cracks within the bounding box.

### CROSS-REFERENCE TO RELATED APPLICATION

This application claims the benefit of Korean Patent Application No. 10-2025-0030504, filed on March 10, 2025, in the Korean Intellectual Property Office, the entire disclosure of which is incorporated herein by reference for all purposes.

### BACKGROUND

### Field of the Invention

One or more embodiments relate to an electronic device and a method of monitoring a crack in a structure.

### Description of the Related Art

As part of social infrastructure, management of key physical infrastructure has emerged as a critical challenge. Particularly, with frequent occurrence of natural disasters such as earthquakes, floods, and typhoons, the need for monitoring safety and durability of a structure has increased. Conventional detection methods primarily rely on human vision or use simple sensors that issue alerts when a certain threshold is exceeded. However, these methods may be difficult to detect subtle changes or cracks in a structure in real time. Particularly, major structures such as cultural properties are sensitive protection targets and require highly accurate and continuous monitoring, which may be even more difficult to detect cracks using the conventional methods.

The above description has been possessed or acquired by the inventor(s) in the course of conceiving the present disclosure and is not necessarily an art publicly known before the present application is filed.

### SUMMARY

Embodiments provide technology of automating displacement detection for multiple points of interest (POIs) using artificial intelligence technology, efficiently analyzing large-scale data, and monitoring states of a major structure in real time.

However, the technical aspects are not limited to the aforementioned aspects, and other technical aspects may be present.

According to an aspect, there is provided a method of monitoring a crack in a structure, the method including obtaining a panoramic image including the structure, setting a plurality of points of interest (POIs) within the panoramic image, by analyzing cracks within the plurality of POIs, generating a bounding box corresponding to each of areas in which the cracks have occurred, and monitoring the cracks within the bounding box.

The obtaining of the panoramic image may include obtaining a plurality of images capturing the structure from one or more cameras and generating the panoramic image based on the plurality of images.

The setting of the plurality of POIs may include setting the plurality of POIs within the panoramic image so that the plurality of POIs does not overlap each other.

The generating of the bounding box may include setting the bounding box to cover all areas in which the cracks have occurred, without overlapping each other.

The monitoring of the cracks may include, by modeling the cracks within the bounding box as polygons, deleting an area unrelated to the cracks within the bounding box and detecting a change in the modeled cracks.

The method may further include, by analyzing a monitoring result, providing an analysis result to a user.

The analysis result may include a change history of the cracks, a real-time state of the cracks, and when emergency damage has occurred for one or more of the cracks, a notification regarding the emergency damage.

According to another aspect, there is provided an electronic device for monitoring a crack in a structure, the electronic device including a processor and a memory configured to store instructions, wherein the instructions may be individually or collectively executed by the processor and may cause the electronic device to obtain a panoramic image including the structure, set a plurality of points of interest (POIs) within the panoramic image, by analyzing cracks within the plurality of POIs, generate a bounding box corresponding to each of areas in which the cracks have occurred, and monitor the cracks within the bounding box.

The instructions may be individually or collectively executed by the processor and may cause the electronic device to obtain a plurality of images capturing the structure from one or more cameras and generate the panoramic image based on the plurality of images.

The instructions may be individually or collectively executed by the processor and may cause the electronic device to set the plurality of POIs within the panoramic image so that the plurality of POIs does not overlap each other.

The instructions may be individually or collectively executed by the processor and may cause the electronic device to set the bounding box to cover all areas in which the cracks have occurred, without overlapping each other.

The instructions may be individually or collectively executed by the processor and may cause the electronic device to by modeling the cracks within the bounding box as polygons, delete an area unrelated to the cracks within the bounding box and detect a change in the modeled cracks.

The instructions may be individually or collectively executed by the processor and may cause the electronic device to, by analyzing a monitoring result, provide an analysis result to a user.

The analysis result may include a change history of the cracks, a real-time state of the cracks, and when emergency damage has occurred for one or more of the cracks, a notification regarding the emergency damage.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates an example of a crack monitoring system according to an embodiment;

FIG. 2 is a diagram illustrating a crack monitoring method according to an embodiment;

FIG. 3 is a diagram illustrating a multi-point of interest (POI) setting operation according to an embodiment;

FIG. 4 is a diagram illustrating polygonal modeling according to an embodiment;

FIG. 5 illustrates an example of a flowchart of a crack monitoring method according to an embodiment; and

FIG. 6 illustrates an example of an electronic device according to an embodiment.

### DETAILED DESCRIPTION

The following structural or functional descriptions of embodiments described herein are merely intended for the purpose of describing the embodiments described herein and may be implemented in various forms. Accordingly, the embodiments are not construed as limited to the disclosure and should be understood to include all changes, equivalents, and replacements within the idea and the technical scope of the disclosure.

Although terms of "first," "second," and the like are used to explain various components, the components are not limited to such terms. These terms are used only to distinguish one component from another component. For example, a first component may be referred to as a second component, or similarly, the second component may be referred to as the first component within the scope of the present disclosure.

When it is mentioned that one component is "connected" or "accessed" to another component, it may be understood that the one component is directly connected or accessed to another component or that still other component is interposed between the two components.

The singular forms "a", "an", and "the" are intended to include the plural forms as well, unless the context clearly indicates otherwise. It will be further understood that the terms "comprises/comprising" and/or "includes/including" when used herein, specify the presence of stated features, integers, steps, operations, elements, and/or components, but do not preclude the presence or addition of one or more other features, integers, steps, operations, elements, components and/or groups thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

Hereinafter, embodiments will be described in detail with reference to the accompanying drawings. When describing the embodiments with reference to the accompanying drawings, like reference numerals refer to like components and a repeated description related thereto will be omitted.

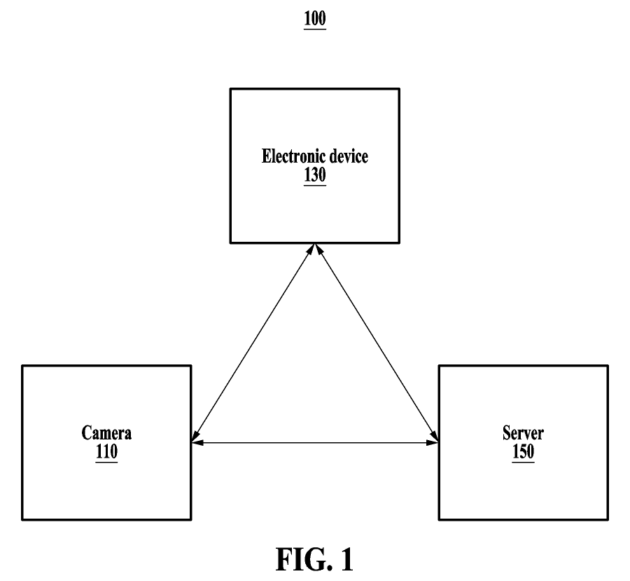

FIG. 1 illustrates an example of a crack monitoring system according to an embodiment.

Referring to FIG. 1, a crack monitoring system 100 may include a camera 110, an electronic device 130, and a server 150. However, FIG. 1 is merely an example for illustrating the present disclosure, and the scope of the present disclosure should not be construed as being limited thereto. For example, the electronic device 130 may monitor a crack independently, without the server 150.

The camera 110 may capture images of an entire structure and/or specific areas from various angles. As shown in FIG. 1, the camera 110 may be implemented as a single camera. When there is only one camera 110, the camera 110 may rotate to capture images of the structure. However, embodiments of the camera 110 are not limited thereto. For example, the camera 110 may be implemented with multiple cameras, and in this case, the multiple cameras may be fixed to capture the entire structure and/or a portion of the structure. In another example, the camera 110 may be implemented with a fisheye camera equipped with a wide-angle lens and/or a multi-image device camera equipped with a plurality of sensors and lenses.

Images or videos captured by the camera 110 may be transmitted to the electronic device 130 and/or the server 150.

The electronic device 130 may control the camera 110. The electronic device 130 may set a capturing method of the camera 110. Based on user input, the electronic device 130 may control the camera 110 according to the capturing method corresponding to the user input. For example, the electronic device 130 may set a screen size, a ratio, and/or resolution of the images (and/or videos) captured by the camera 110 according to the user input. In addition, the electronic device 130 may set a capturing angle and position of the camera 110 according to the user input.

The camera 110, the electronic device 130, and the server 150 may communicate using a network (not shown). For example, the network may include a local area network (LAN), a wide area network (WAN), a value added network (VAN), a mobile radio communication network, a satellite communication network, and combinations thereof. The network is a comprehensive data communication network that allows the camera 110, the electronic device 130, and the server 150 to communicate with each other smoothly, and may include wired Internet, wireless Internet, and mobile wireless communication networks. In addition, the wireless communication networks may include, but are not limited to, wireless LAN (e.g., wireless fidelity (Wi-Fi)), Bluetooth, Bluetooth low energy, Zigbee, Wi-Fi Direct (WFD), ultra-wideband (UWB), infrared communication (infrared data association (IrDA)), near field communication (NFC), or the like.

Some and/or all of operations performed by the server 150 may also be performed by the electronic device 130 and/or the server 150. Hereinafter, a description is provided based on an assumption that the electronic device 130 performs the operations.

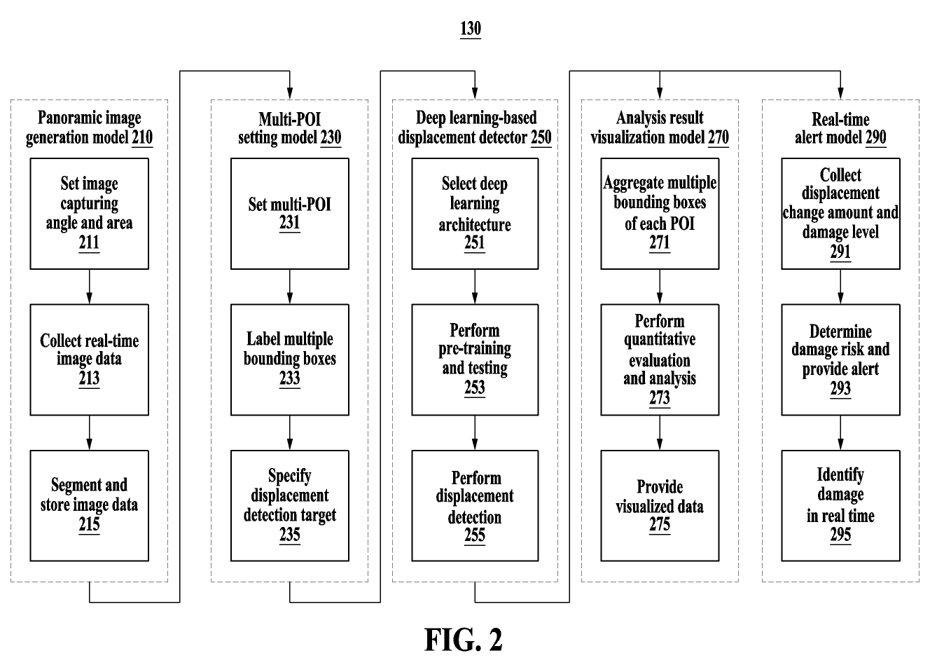

The electronic device 130 may collect panoramic image data in real time, may detect (or monitor) crack displacements of multiple points of interest (POIs) using deep learning technology, and may analyze the crack displacements in real time. A specific crack monitoring method is described in detail with reference to FIG. 2.

FIG. 2 is a diagram illustrating a crack monitoring method according to an embodiment.

Referring to FIG. 2, the electronic device 130 may include a panoramic image generation model 210, a multi-POI setting model 230, a deep learning-based displacement detector 250, an analysis result visualization model 270, and a real-time alert model 290.

The electronic device 130 may obtain a panoramic image including a structure. For example, the electronic device 130 may obtain a plurality of images capturing the structure from one or more cameras (e.g., the camera 110 of FIG. 1) and may stitch the plurality of images together using the panoramic image generation model 210 to generate the panoramic image. In another example, the electronic device 130 may also obtain (e.g., receive) the panoramic image capturing the structure from the camera 110 (e.g., a panoramic image generation device).

The electronic device 130 may control the camera 110 to obtain the panoramic image (or video). Specifically, the panoramic image generation model 210 may control the camera 110 and may obtain the panoramic image through operations 211 to 215. Each of operations 211 to 215 is described in detail below.

In operation 211, the panoramic image generation model 210 may set an image capturing angle and area of the camera 110. The panoramic image generation model 210 may set the image capturing angle and specific area of the camera 110, may store collected real-time image data (e.g., images and/or panoramic images), and may utilize the collected real-time image data for displacement detection. By setting the image-capturing angle and area of the camera 110, the panoramic image generation model 210 combines multiple pieces of image data into a single wide field of view and designates a specific region within the synthesized image, thereby allowing more detailed analysis.

In operation 213, the panoramic image generation model 210 may collect real-time images and/or panoramic images from the camera 110. The panoramic image generation model 210 may continuously receive the images and/or panoramic images from the camera 110.

In operation 215, the panoramic image generation model 210 may segment and store the image data. The panoramic image generation model 210 may segment and store the collected images and/or panoramic images according to requirements of a user for smooth displacement detection and analysis.

The electronic device 130 may set a plurality of POIs within the panoramic image. The electronic device 130 may analyze cracks within the plurality of POIs and may monitor only direct areas in which the cracks have occurred. The electronic device 130 may generate a bounding box corresponding to each of the areas in which the cracks have occurred within the plurality of POIs. Rather than detecting the entire area of the panoramic image, the electronic device 130 may monitor a portion (e.g., an area corresponding to a POI) of the panoramic image. By monitoring only a portion of the panoramic image, the electronic device 130 may monitor only areas associated with the cracks in an actual structure. This allows the electronic device 130 to detect subtle changes or cracks in the structure within the panoramic image. Specifically, the electronic device 130 may set the plurality of POIs through operations 231 to 235. Each of operations 231 to 235 is described in detail below.

In operation 231, the multi-POI setting model 230 may set the plurality of POIs within the panoramic image. The multi-POI setting model 230 may generate an anchor box corresponding to a POI. The multi-POI setting model 230 may set the plurality of POIs within the panoramic image so that the plurality of POIs does not overlap each other. In other words, the multi-POI setting model 230 may generate anchor boxes so that the anchor boxes do not overlap each other. The multi-POI setting model 230 may support multi-POI setting to accurately monitor multiple points of a detection target. The multi-POI setting may be performed simultaneously for multiple locations, allowing more effective multi-angle displacement detection.

In operation 233, the multi-POI setting model 230 may label multiple bounding boxes. The multi-POI setting model 230 may analyze the cracks within the plurality of POIs and may generate the bounding box corresponding to each of the areas in which the cracks have occurred (e.g., displacement detection areas). The multi-POI setting model 230 may set the bounding box to cover all areas in which the cracks have occurred, without overlapping each other.

In operation 235, the multi-POI setting model 230 may specify a displacement detection target. The multi-POI setting model 230 may model and specify a target crack in which displacement is to be detected within the bounding box. The bounding box may be implemented in a rectangular shape and may include areas not directly related to the cracks. Accordingly, the multi-POI setting model 230 may model the cracks within the bounding box as polygons and may delete the areas unrelated to the cracks within the bounding box.

The electronic device 130 may monitor (or detect) the cracks within the bounding box. The electronic device 130 may detect changes in the cracks through the deep learning-based displacement detector 250. The electronic device 130 may detect the changes in the cracks corresponding to the areas modeled as a polygon through the deep learning-based displacement detector 250. The deep learning-based displacement detector 250 may detect the changes in a set POI area in real time by using an optimized displacement detection model based on a pre-trained deep learning architecture. Specifically, the electronic device 130 may monitor (or detect, sense, or observe) the changes in the cracks through operations 251 to 255. Each of operations 251 to 255 is described in detail below.

In operation 251, the deep learning-based displacement detector 250 may select a deep learning architecture (or a deep learning model and an artificial intelligence model). The deep learning architecture may be implemented with various artificial intelligence models used for displacement detection. The deep learning architecture may contribute to improving accuracy of displacement detection through image analysis.

In operation 253, the deep learning-based displacement detector 250 may perform pre-training and testing of the selected deep learning architecture. The deep learning-based displacement detector 250 may pre-train the deep learning architecture and may test the deep learning architecture using real image data. Based on test results, the deep learning-based displacement detector 250 may evaluate accuracy of the deep learning architecture and may improve the model.

In operation 255, the deep learning-based displacement detector 250 may detect the changes in the cracks in real time by using the pre-trained model, and the detected changes in the cracks may be transmitted to the analysis result visualization model 270 and the real-time alert model 290.

The electronic device 130 may analyze monitoring results and may provide analysis results to the user. The analysis results may include one or more of a change history of the cracks, a real-time state of the cracks, and when emergency damage has occurred for one or more of the cracks, a notification regarding the emergency damage. The analysis results may be provided to the user through the analysis result visualization model 270. Furthermore, when the analysis results indicate that a rapid change occurs in a crack, causing emergency damage, the real-time alert model 290 may notify the user of the emergency damage.

Hereinafter, specific operations of the analysis result visualization model 270 and the real-time alert model 290 are described in detail.

The analysis result visualization model 270 may perform displacement analysis on the multiple bounding boxes to derive comprehensive results. The analysis result visualization model 270 may convert detected displacement changes and damage to visualized data and may transmit the visualized data to the user, thereby supporting the user to understand the state in real time.

In operation 271, the analysis result visualization model 270 may aggregate crack changes (e.g., the monitoring results) of the multiple bounding boxes for each POI. The analysis result visualization model 270 may combine data on the crack changes of the multiple bounding boxes analyzed in the images of each POI to determine full extent of the damage or a range of displacement.

In operation 273, the analysis result visualization model 270 may quantitatively evaluate and analyze the monitoring results (e.g., results of detecting the changes (or displacements) of the cracks within the bounding box). The analysis result visualization model 270 may analyze and organize aggregated values for the crack changes and damage.

In operation 275, the analysis result visualization model 270 may provide the visualized data regarding the monitoring results. The analysis result visualization model 270 may visualize the monitoring results so that relevant parties may easily understand the monitoring results. The analysis result visualization model 270 may provide a function of visually displaying displacement and damage data in real time.

The real-time alert model 290 may provide a notification to the user when emergency damage occurs in the monitored crack (e.g., the target crack) (e.g., the crack modeled as a polygon to be monitored).

In operation 291, the real-time alert model 290 may collect the displacement change and damage level of the crack. The real-time alert model 290 may continuously collect data related to the displacement or damage and may generate an alert message based on this data.

In operation 293, the real-time alert model 290 may analyze the collected data in real time using an algorithm for evaluating damage risk and may determine a risk state. The determined risk state may be immediately converted into the alert message and transmitted to the relevant parties.

In operation 295, the real-time alert model 290 may identify the damage in real time. The real-time alert model 290 may provide the damage notification based on the real-time analysis results. The notification may be transmitted through various electronic devices (e.g., smartphones, laptops, desktops, etc.) of the user and may be quickly delivered to the user.

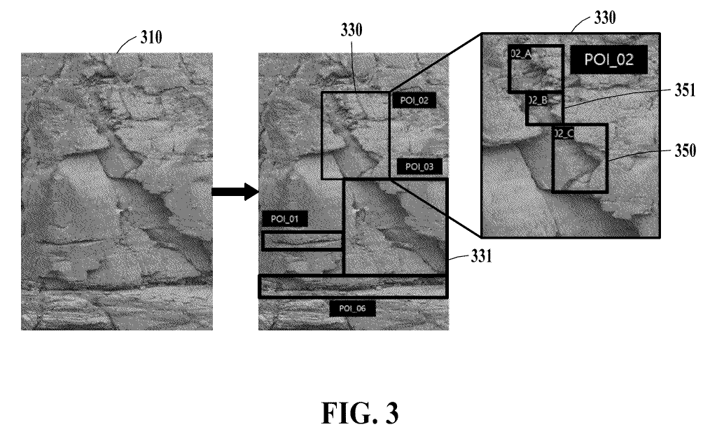

FIG. 3 is a diagram illustrating a multi-POI setting operation according to an embodiment.

Referring to FIG. 3, an electronic device (e.g., the electronic device 130 of FIG. 1) may set multiple POIs, may automatically designate a bounding box for each POI, and may precisely set a displacement detection target.

The electronic device 130 may set a plurality of POIs (e.g., POIs 330 and 331) in an image 310 received from a camera (e.g., the camera 110 of FIG. 1). The electronic device 130 may set the multiple POIs to be detected according to determination of a user or artificial intelligence, based on data in which image data is segmented and stored using a distinguished suffix after capturing by the camera 110.

The electronic device 130 may generate anchor boxes (e.g., boxes labeled as POI_01 to POI_06) corresponding to each of the POIs 330 and 331 to identify each of the POIs 330 and 331. Each of the POIs 330 and 331 may be set so as not to overlap each other.

The electronic device 130 may analyze cracks within the POIs 330 and 331 and may generate bounding boxes 350 and 351. For ease of description, bounding boxes generated for the POI 330 are shown in FIG. 3, but substantially the same bounding boxes may be generated for other POIs (e.g., the POI 331). The electronic device 130 may precisely monitor multiple areas through the multiple bounding boxes 350 and 351.

The electronic device 130 may perform precise monitoring by deleting portions unrelated to the cracks within the bounding boxes 350 and 351 and targeting only the cracks. This is substantially the same as operations 233 to 235 of FIG. 2, and thus, a repeated description thereof is omitted.

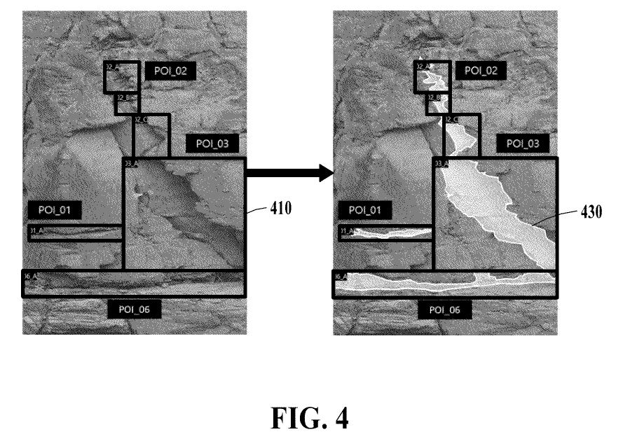

FIG. 4 is a diagram illustrating polygonal modeling according to an embodiment.

Referring to FIG. 4, an electronic device (e.g., the electronic device 130 of FIG. 1) may model cracks within a bounding box as a polygon. Since the bounding box may be implemented as a rectangle, the bounding box corresponding to a crack may be generated by including areas unrelated to actual cracks. Therefore, to detect only areas directly related to the cracks, the electronic device 130 may model the cracks as polygons. Although FIG. 4 shows the cracks modeled as polygons within a plurality of bounding boxes, for ease of description, a description with respect to a bounding box 410 is provided in detail below. However, the description below may be applied to other bounding boxes substantially in the same manner.

The electronic device 130 may model the cracks within the bounding box 410 as polygons. The electronic device 130 may delete areas unrelated to the cracks, excluding an area 430 modeled as polygons within the bounding box 410.

The electronic device 130 may improve accuracy of crack monitoring by monitoring (or detecting) only the area 430 modeled as polygons using a deep learning model (or architecture) (e.g., the deep learning-based displacement detector 250 of FIG. 2).

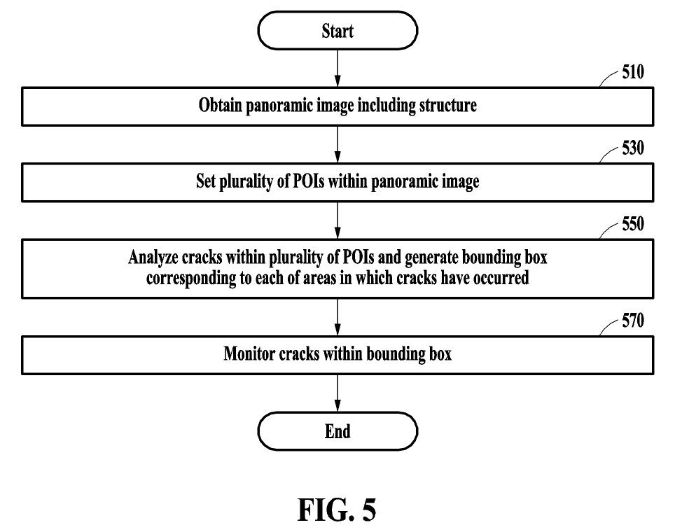

FIG. 5 illustrates an example of a flowchart of a crack monitoring method according to an embodiment.

Referring to FIG. 5, operations 510 to 570 may be performed sequentially but are not limited thereto. For example, two or more operations may be performed in parallel. Operations 510 to 570 may be substantially the same as operations of the electronic device (e.g., the electronic device 130 of FIG. 1) described with reference to FIGS. 1 to 4. Therefore, a detailed description thereof is omitted.

In operation 510, the electronic device 130 may obtain a panoramic image including a structure.

In operation 530, the electronic device 130 may set a plurality of POIs within the panoramic image.

In operation 550, the electronic device 130 may analyze cracks within the plurality of POIs and may generate a bounding box corresponding to each of areas in which the cracks have occurred.

In operation 570, the electronic device 130 may monitor the cracks within the bounding box.

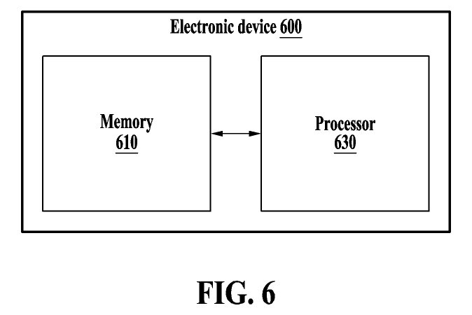

FIG. 6 illustrates an example of an electronic device according to an embodiment.

Referring to FIG. 6, an electronic device 600 may include a memory 610 and a processor 630. The descriptions provided with reference to FIGS. 1 to 5 may also be applied to FIG. 6. For example, the electronic device 130 of FIG. 1 may be the electronic device 600.

The memory 610 may store instructions (e.g., programs) executable by the processor 630. For example, the instructions may include instructions for executing operations of the processor 630 and/or operations of each component of the processor 630.

The memory 610 may be implemented as a volatile memory device or a non-volatile memory device.

The volatile memory device may be implemented as dynamic random-access memory (DRAM), static random-access memory (SRAM), thyristor RAM (T-RAM), zero capacitor RAM (Z-RAM), or twin transistor RAM (TTRAM).

The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase-change RAM (PRAM), resistive RAM (RRAM), nanotube RRAM, polymer RAM (PoRAM), nano floating gate memory (NFGM), holographic memory, a molecular electronic memory device, or insulator resistance change memory.

The processor 630 may process data stored in the memory 610. The processor 630 may execute computer-readable code (e.g., software) stored in the memory 610 and instructions triggered by the processor 630.

The processor 630 may be a data processing device implemented by hardware including a circuit having a physical structure to perform desired operations. The desired operations may include, for example, code or instructions included in a program.

The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The processor 630 may cause the electronic device 600 to perform one or more operations by executing code and/or instructions stored in the memory 610. The operations performed by the electronic device 600 may be substantially the same as the operations performed by the electronic device 130 described with reference to FIGS. 1 to 5. Accordingly, a repeated description is omitted.

The components described in the embodiments may be implemented by hardware components including, for example, at least one digital signal processor (DSP), a processor, a controller, an ASIC, a programmable logic element, such as an FPGA, other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using hardware components, software components, or a combination thereof. A processing device may be implemented using one or more general-purpose or special purpose computers, such as, for example, a processor, a controller and an arithmetic logic unit, a DSP, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the above-described embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The media may be transfer media such as optical lines, metal lines, or waveguides including a carrier wave for transmitting a signal designating the program command and the data construction. Examples of program instructions include both machine code, such as code produced by a compiler, and files containing higher level code that may be executed by the computer using an interpreter.

The described hardware devices may be configured to act as one or more software modules in order to perform the operations of the above-described embodiments, or vice versa.

While this disclosure includes embodiments, it will be apparent to one of ordinary skill in the art that various changes in form and details may be made in these embodiments without departing from the spirit and scope of the claims and their equivalents. The embodiments described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method of monitoring a crack in a structure, the method comprising:
obtaining a panoramic image comprising the structure;
setting a plurality of points of interest (POIs) within the panoramic image;
by analyzing cracks within the plurality of POIs, generating a bounding box corresponding to each of areas in which the cracks have occurred; and
monitoring the cracks within the bounding box.

2. The method of claim 1, wherein
the obtaining of the panoramic image comprises:
obtaining a plurality of images capturing the structure from one or more cameras; and
generating the panoramic image based on the plurality of images.

3. The method of claim 1, wherein
the setting of the plurality of POIs comprises setting the plurality of POIs within the panoramic image so that the plurality of POIs does not overlap each other.

4. The method of claim 1, wherein
the generating of the bounding box comprises setting the bounding box to cover all areas in which the cracks have occurred, without overlapping each other.

5. The method of claim 1, wherein
the monitoring of the cracks comprises:
by modeling the cracks within the bounding box as polygons, deleting an area unrelated to the cracks within the bounding box; and
detecting a change in the modeled cracks.

6. The method of claim 1, further comprising:
by analyzing a monitoring result, providing an analysis result to a user.

7. The method of claim 6, wherein
the analysis result comprises a change history of the cracks, a real-time state of the cracks, and when emergency damage has occurred for one or more of the cracks, a notification regarding the emergency damage.

8. An electronic device for monitoring a crack in a structure, the electronic device comprising:
a processor; and
a memory configured to store instructions,
wherein the instructions are individually or collectively executed by the processor and cause the electronic device to:
obtain a panoramic image comprising the structure;
set a plurality of points of interest (POIs) within the panoramic image;
by analyzing cracks within the plurality of POIs, generate a bounding box corresponding to each of areas in which the cracks have occurred; and
monitor the cracks within the bounding box.

9. The electronic device of claim 8, wherein
the instructions are individually or collectively executed by the processor and cause the electronic device to:
obtain a plurality of images capturing the structure from one or more cameras; and
generate the panoramic image based on the plurality of images.

10. The electronic device of claim 8, wherein
the instructions are individually or collectively executed by the processor and cause the electronic device to set the plurality of POIs within the panoramic image so that the plurality of POIs does not overlap each other.

11. The electronic device of claim 8, wherein
the instructions are individually or collectively executed by the processor and cause the electronic device to set the bounding box to cover all areas in which the cracks have occurred, without overlapping each other.

12. The electronic device of claim 8, wherein
the instructions are individually or collectively executed by the processor and cause the electronic device to:
by modeling the cracks within the bounding box as polygons, delete an area unrelated to the cracks within the bounding box; and
detect a change in the modeled cracks.

13. The electronic device of claim 8, wherein
the instructions are individually or collectively executed by the processor and cause the electronic device to, by analyzing a monitoring result, provide an analysis result to a user.

14. The electronic device of claim 8, wherein
the analysis result comprises a change history of the cracks, a real-time state of the cracks, and when emergency damage has occurred for one or more of the cracks, a notification regarding the emergency damage.
